(19) United States
(12) Patent Application Publication
(10) Pub. No.: US 2017/0044052 A1
(43) Pub. Date: Feb. 16, 2017

(54) Process to Co-Mill Waste Fiberglass With Post-Consumer Glass Into Powder

(71) Applicant: Urban Mining Northeast, LLC, New Rochelle, NY (US)

(72) Inventors: Louis P. Grasso, JR., New Rochelle, NY (US); Dale Hauke, Riviera Beach, FL (US)

(73) Assignee: Urban Mining Northeast, LLC, New Rochelle, NY (US)

(21) Appl. No.: 15/231,226

(22) Filed: Aug. 8, 2016

Related U.S. Application Data
(60) Provisional application No. 62/204,865, filed on Aug. 13, 2015.

(51) Int. Cl. C03C 12/00; C09C 1/28; C04B 14/22; C03B 37/14; C03B 37/16

(52) U.S. Cl. CPC C03C 12/00; C03B 37/14; C03B 37/16; C04B 14/22; C09C 1/28

(57) ABSTRACT

A method of making an alkali glass powder includes obtaining down chute waste fiberglass (DCWF) and post-consumer waste glass (PCWG), processing the DCWF into a DCWF particulate form, combining the DCWF and PCWG at a ratio of PCWG to DCWF, and co-grinding the combined DCWF particulate form and the PCWG into a DCWF-PCWG powder having an alkali content based on the ratio of PCWG to DCWF.

### BACKGROUND OF THE INVENTION

1. Field of the Invention

The present invention relates to the processing of waste glass into a pozzolan and industrial fillers.

2. State of the Art

The manufacture of fiberglass (FG) results in 10% to 20% of the material produced being off-specification and is often called “down chute waste fiberglass” (DCWF) or “basement waste”. Although some plants recycle DCWF back into fiberglass raw material, most is landfilled because of the difficulty in processing it.

### SUMMARY OF THE INVENTION

In accord with one aspect of the invention, it has been demonstrated that when cut into six inch strands or smaller, down chute waste fiberglass (DCWF) can be milled to a fine powder for use in conjunction with post-consumer waste glass (PCWG), primarily in the form of an alkali-rich bottle glass (BG), as a pozzolan in concrete products or as an industrial filler in coatings and resins. The process to convert DCWF into a pozzolan or an industrial filler includes the following principal steps:

1. The DCWF strands are chopped into pieces 55 microns to six inches in length.

2. The chopped strands are optionally pulverized to 20 mesh (850 microns) and smaller.

3. The post-consumer waste glass is optionally prepared for co-grinding (if necessary).

4. The DCWF is combined with PCWG in a grinding device in a closed loop circuit with an air classifier.

5. The ground glass is optionally reclassified to produce smaller particle sizes.

### BRIEF DESCRIPTION OF THE DRAWINGS

FIG. 1 is a photograph of down chute waste fiberglass.

FIG. 2 is a photograph of a bulk bin of down chute waste fiberglass.

FIG. 3 is a flow diagram of the process to co-mill waste fiberglass with post-consumer waste glass into a powder.

### DETAILED DESCRIPTION OF THE PREFERRED EMBODIMENTS

In accord with the method herein, the following preferred steps are provided to process waste fiberglass and post-consumer waste glass into a finely ground powder suitable for use as pozzolan or industrial filler.

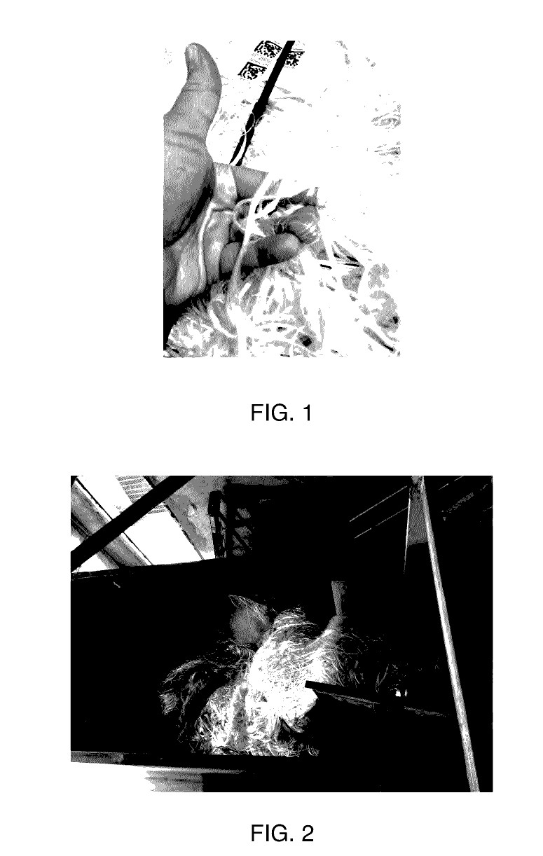

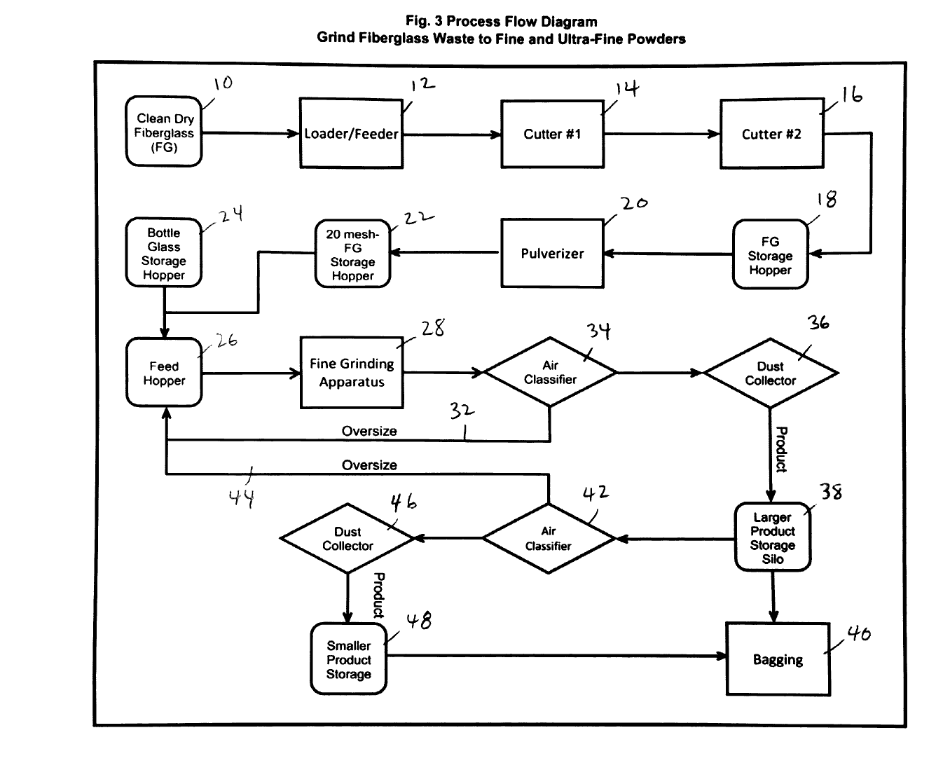

Referring to FIGS. 1 and 2, down chute waste fiberglass (DCWF) strands are obtained at step 10. The DCWF is obtained in strands from approximately one foot long to over 20 feet in length. The strands are randomly oriented and can be grouped in mats from small to large size. The DCWF feed is typically clean and dry. However, if the DCWF arrives with a significant moisture content; i.e., greater than 1% moisture, then the DCWF preferably is dried by any type of drying apparatus.

In order to mill the dry and matted strands of DCWF into a fine powder, the strands are first reduced in size. To reduce the size of the DCWF, the long strands of DCWF are fed into a loader/feeder at step 12. More particularly, the DCWF is picked up off a tipping floor by any number of different methods including, but not limited to, a grapple or claw attached to a cable powered by an overhead crane, a forklift or bucket loader equipped with a hook, grapple or claw type device. The material is placed on a hydraulically operated tipping plate that raises and dumps the DCWF into an automatic feeder or the material is fed directly into the automatic feeder. The feeder floor contains a plurality, e.g., four, metal bars equipped with alternating moving teeth that pull the multiple strands apart and push the strands of DCWF toward a cutter system to cut the DCWF to the appropriate length as it is conveyed out of the feeder.

In a preferred method, as the material exits the feeder and is conveyed toward the cutter system, it passes across metal detectors that detect any type of metal. Upon detection, the detection signal the process to stop to allow manual removal of metals and any other debris observed, which could significantly damage the chopping blades of the cutter system if not removed. At this stage other non-metal foreign objects, if observed, are also removed. Automatic removal of ferrous and non-ferrous metals and other foreign objects can also be performed. Although these safeguards are in place, it is preferable that foreign materials do not get into the DCWF stream at the fiberglass plant.

After foreign object removal, the DWCF is received at the cutting system, which, in one embodiment, includes a first cutter system at step 14 and a second cutter system at step 16. Suitable first cutter systems include, but are not limited to, guillotine type choppers and a variety of laser cutters, which are capable of reducing the strand size into pieces ¼ inch to six inches in length.

One type of guillotine cutting system consists of a tipping plate, automatic feeder, two metal detectors, two guillotine type choppers and associated conveyors. In such a system, the DCWF is conveyed to a first guillotine chopper at step 14. The speed of the conveyor and revolutions per minute of the guillotine blades are set to chop the material to the desired length, normally between ¼ inch and six inches. Since the strands can enter the first chopper at any angle, those strands entering parallel to the chopper blades will exit as long as the width of the guillotine blades. Strands that enter the first chopper perpendicular to it are cut into the desired length. Strands that enter at angles between parallel and perpendicular are chopped into varying lengths depending on the angle.

In order to chop all of strands to the desired length, the material from the first cutting system is conveyed to a belt oriented at a right angle that conveys material to a second cutting system, such as second guillotine chopper, at step 16. The strands that were parallel to the first chopper are now perpendicular to the second chopper yielding the desired length and smaller. Since the orientation of the strands in the raw material is variable and random, the final length of the pieces will vary but will be less than a maximum desired length when the system is in adjustment. Any variation on this setup of guillotine choppers that achieve the same result is an acceptable method.

There are a number of cloth laser cutting systems that alternatively may be used to cut DCWF. Most are categorized as CO₂ laser cutters that come in several variations including fast axial flow, slow axial flow, transverse flow, and slab. A flatbed CO₂ laser cutter system can also be used to DCWF to appropriate lengths. Similar to the guillotine chopper system, two flatbed cutters oriented perpendicular to the DCWF stream, in order to cut the randomly oriented strands to the desired length, also can be used.

Also, a rotary blade cutter system may be used as another alternative to the embodiment of the cutting system described above (including cutter systems 14 and 16). One type of rotary blade cutter is a screen classifying cutter (SCC) that employs a helical rotor design with interconnected parallelogram cutters. In a test using three inch fiberglass strands as feed material, one pass through the SCC reduced the strands to an average length of 55 micron.

The chopped strands of DCWF are then sent to a storage hopper at step 18. Many fine grinding devices will see increase throughput rates when fed smaller material. A ball mill, for example, will see a significant increase in productivity when fed with material 20 mesh and smaller. The optimal size depends on the material being ground and the type of grinding device.

From the storage hopper, the chopped strands of DCWF are optionally pulverized at step 20 to a smaller size (by way of example, 20 mesh minus and smaller) utilizing a vertical shaft impactor (VSI) mill or other suitable mill. A VSI mill comminutes particles of material into smaller particles by impacting the particles against a hard surface inside the mill (called the wear plate) via an accelerator, or rotor, spinning at a high angular velocity. One pass through the VSI mill normally reduces the size of the DCWF sufficiently. The pulverized DCWF is then stored in a hopper at step 22.

Post-consumer waste glass (PCWG), preferably in the form of bottle glass, is obtained. To the extent necessary, the bottle glass is prepared for co-grinding. Because such preparation may not be necessary, the step is optional. However, if the bottle glass is provided dirty or with debris, or of a size too large to initiate co-grinding, then it will need to be sufficiently cleaned and/or prepared in size. Various methods for cleaning PCWG can be used. One method is described in U.S. Pat. No. 7,745,466, which is hereby incorporated by reference herein in its entirety. Regardless, clean post-consumer bottle glass is provided to a hopper at step 24.

Clean post-consumer bottle glass can come in a range of sizes depending on how the glass was cleaned. The size of bottle glass for co-grinding with chopped fiberglass generally range from 1¼ inches minus to 20 mesh minus. The preferred size for co-grinding with fiberglass is ¼ inch minus. If the size of the glass is larger than ¼ inch, it can be reduced to this size by several pulverizing and crushing technologies including, but not limited to, hammer mills, jet mills, vertical shaft impactor (VSI) mills, jaw crushers, etc. The preferred technology is a VSI mill. The appropriately sized VSI mill can reduce bottle glass to ¼ inch minus in one pass at high throughput rates.

Once the bottle glass is prepared, the DCWF and bottle glass are then fed via a feed hopper at step 26 into a fine grinding device at step 28. This preferably occurs in a closed loop circuit with a dynamic air classifier 32. Co-grinding the DCWF with post-consumer bottle glass accomplishes two objectives: (1) the bottle glass serves as a grinding aid increasing the productivity of the grinding apparatus, and (2) it allows for making powdered glass product with a sodium content controlled by the ratio of bottle glass to fiberglass. Any ratio of bottle glass to fiberglass can be employed; from 1% bottle glass to 99% bottle glass.

A study was performed in which bottle glass was co-milled with fiberglass at ratios of 10%-90%, 40%-60%, and 60%-40%. The results are shown in Table 1.

TABLE 1
Summary of Chemical Analyses

| | Median | | | | | |
|---|---|---|---|---|---|---|
| | Particle | | | | | |
| | Size | | | | Moisture | |
| Sample ID | (μm) | % FG | % BG | % Na₂O | % | LOI |
| 072715 12:56 | 7.5 | 90 | 10 | 3.26 | 0.11 | 0.42 |
| 072415 14:21 | 10.0 | 90 | 10 | 3.59 | 0.11 | 0.40 |
| 3/6/2015 12:29 | 10.0 | 60 | 40 | 6.00 | 0.28 | 0.48 |
| 3/5/2015 7:43 | 10.0 | 40 | 60 | 8.78 | 0.19 | 0.56 |

There is a linear relationship between the percent of bottle glass and the alkali (Na₂O; i.e., sodium oxide) content in the co-milled product. This provides the ability to produce powders that match the sodium content to the requirements of the end user. Given the linear relationship, glass powders can be produced, with a selected and determined percentage of alkali content or a range of content: 3-4% alkali content (e.g., 90% DCWF+10% PCWG), <5% alkali content (e.g., >90% DCWF+<10% PCWG), 3-6% alkali content (e.g., 60-90% DCWF+10-40% PCWG), <6% alkali content (e.g., >60% DCWF+<10% PCWG), 3-10% alkali content (e.g., 40-90% DCWF+60-10% PCWG). In view of the linear relationship, with approximately 100% DCWF, the alkali content is less than 1%, and with approximately 100% PCWG, the alkali content approaches 15%. Therefore, a combination of the DCWF and PCWG should have a selectable and determinable alkali content between 1% and 15%.

A material flow of bottle glass and chopped, or chopped and pulverized, fiberglass at the desired proportions will be simultaneously fed into a hopper that feeds an appropriately sized grinding device. Fine grinding can occur in several types of fine grinding apparatus including, but not limited to, all types of ball mills and tube mills, attrition mills (stirred media mills and dense packed stirred media mills), vibratory mills, jet mills (or air classification mills) and ISA mills.

At the outlet end of the fine grinding apparatus, material is swept pneumatically to an air classifier at step 34 that separates out product of the desired particle size distribution (for example, a powder with a median particle size of 11 micron). The oversize material (i.e., circulating load) is conveyed at 32 directly back to the hopper 26 that feeds the fine grinding apparatus 28 for further grinding. The finely ground final product is separated from the airstream and collected by a dust collection device at step 36 including, but not limited to various cyclonic and baghouse technologies. Once the product is collected, it is conveyed for storage and transfer to silos at step 38 (large product) as needed by the mix of products ultimately produced. From the silos 38, the glass powder products can be bagged at step 40 for transport.

As an option, if it is desirable to produce smaller particle sizes, the finely co-ground material is pneumatically conveyed to and reclassified in one or more air classifiers at step 42 to produce smaller products (for example, median particle size of 7.5 and 3.5 micron). The oversize material from these air classifiers is conveyed at step 44 to a hopper that feeds the ball mill.

The final ultra-fine product(s) is separated from the airstream and collected by a dust collection device at step 46 including, but not limited to various cyclonic and baghouse technologies and stored at step 48. Another option for making smaller glass powders is to utilize an ultra-fine grinding technology that can produce a powder with a median particle size below one micron. This includes, but is not limited to, dense packed stirred media mills, vibratory mills and jet mills.

There have been described and illustrated herein embodiments of a process to co-grind waste fiberglass and post-consumer waste glass, and products resulting from the process. While particular embodiments of the invention have been described, it is not intended that the invention be limited thereto, as it is intended that the invention be as broad in scope as the art will allow and that the specification be read likewise. Thus, while a particular alkali glass source (bottle glass) has been disclosed, it will be appreciated that another source of alkali glass can be used as well. In addition, while particular a particular source of non-alkali glass (fiberglass waste) has been disclosed, it will be understood that other non-alkali glass can be co-ground with the alkali glass to obtain a measured alkali glass powder. Furthermore, while particular preferred choppers, cutters, and mills have been described, it will be understood that other devices and systems that can perform at least as well, or at least suitably for the purposes herein, can be similarly used. It will therefore be appreciated by those skilled in the art that yet other modifications could be made to the invention without deviating from its scope as claimed.

What is claimed is:

1. A method of making an alkali powder, the method comprising:
providing clean and dry down chute waste fiberglass (DCWF) and clean and dry post-consumer waste glass (PCWG);
processing the DCWF into particulate DCWF;
providing the particulate DCWF and PCWG at a ratio of PCWG to DCWF; and
co-grinding the combined particulate DCWF and the PCWG into a DCWF-PCWG powder having an alkali content based on the ratio.

2. The method according to claim 1, wherein:
the DCWF includes at least one of loose strands of fiberglass and mats of stranded fiberglass.

3. The method according to claim 1, wherein:
processing the DCWF includes at least one of cutting the DCWF into smaller strands and grinding the smaller strands into the particulate DCWF.

4. The method according to claim 3, wherein:
cutting the DCWF into smaller strands includes cutting the DCWF strands into pieces of 55 microns to 6 inch long, and grinding the smaller strands into DCWF powder includes grinding the smaller strands into the particulate DCWF having a particle size not exceeding 20 mesh.

5. The method according to claim 4, wherein:
cutting the DCWF includes (1) first cutting the DCWF along a first direction, and second cutting the DCWF along a second direction transverse to the first direction or (2) cutting the DCWF with a rotary blade cutter.

6. The method according to claim 1, wherein:
providing PCWG includes obtaining PCWG having a particle size of less than 1.25 inch.

7. The method according to claim 1, further comprising:
separating DCWF-PCWG powder having a particle size above a first threshold size from DCWF-PCWG powder particles having a size equal to or below the first threshold; and
co-grinding the separated DCWF-PCWG powder having a particle size above the first threshold with the combined particulate DCWF and the PCWG to further reduce the size of the separated DCWF-PCWG powder.

8. The method according to claim 7, further comprising:
first storing DCWF-PCWG powder particles having a size equal to or below the first threshold.

9. The method according to claim 8, further comprising:
separating particles from the DCFW-PCWG powder of the first storing into particles having a particle size that is greater than a second threshold size and particles having a particle size that is less than or equal to the second threshold; and
co-grinding the separated DCWF-PCWG powder having a size above the second threshold with the DCWF-PCWG powder having a particle size above the first threshold.

10. The method according to claim 9, further comprising:
second storing DCWF-PCWG powder particles having a particle size that is less than or equal to the second threshold in a second product container.

11. A method of making an alkali powder, the method comprising:
providing clean and dry down chute waste fiberglass (DCWF);
providing clean and dry post-consumer waste glass (PCWG);
processing the DCWF into particulate DCWF;
combining the particulate DCWF and PCWG; and
co-grinding the combined particulate DCWF and the PCWG into a DCWF-PCWG powder.

12. A system for making an alkali powder, the system comprising:
a first feeder for receiving down chute waste fiberglass (DCWF);
at least one cutter for cutting the DCWF into particulate DCWF a second feeder for combining post-consumer waste glass (PCWG) with an alkali content with the particulate DCWF; and
a co-grinding apparatus for co-grinding the particulate DCWF and the PCWG into a DCWF-PCWG powder, the DCWF-PCWG powder having an alkali content based on a ratio of the PCWG to DCWF.

13. The system of claim 12, wherein:
the second feeder combines the DCWF and PCWG at the ratio of PCWG to DCWF, wherein the ratio is selectable.

14. The system of claim 12, wherein:
the at least one cutter includes: a first cutter for cutting the DCWF along a first direction; and
a second cutter for cutting the DCWF along a second direction transverse to the first direction, wherein the first cutter and the second cutter are configured to cut stranded DCWF into pieces that are ¼ inch to 6 inches.

15. The system of claim 14, further comprising:
an impactor located between the second cutter and the second feeder to impact the DCWF into particle form after being cut by the second cutter, wherein the impacted DCWF has a particle size that is less than or equal to 20 mesh.

16. The system of claim 12, wherein:
the at least one cutter includes a rotary blade cutter configured as a screen classifying cutter, wherein the rotary blade cutter is configured to cut stranded DCWF into pieces that have an average size of 55 microns.

17. The system of claim 12, further comprising:
an air classifier configured to receive the DCWF-PCWG powder and return some of the DCWF-PCWG powder to the second feeder, wherein the returned DCWF-PCWG powder has a size that is larger than a threshold size.

18. The system of claim 17, wherein:
the air classifier is configured to discharge to a storage container a remainder of the DCWF-PCWG powder that has a particle size less than or equal to the threshold size.

19. An alkali powder product comprising:
down chute waste fiberglass (DCWF); and
post consumer waste glass (PCWG) having an alkali content greater than the DCWF, the PCWG mixed with the DCWF at a ratio of PCWG to DCWF, the PCWG and DCWF being co-ground into a PCWG-DCWF powder having an alkali content based on the ratio of PCWG to DCWF.

20. The alkali powder mixture according to claim 19, wherein:
the PCWG includes alkali-containing bottle glass.

21. The alkali powder mixture of claim 19, wherein:
the alkali content is a linear function of the percentage of PCWG in the mixture.

22. The alkali powder mixture of claim 19, wherein:
the mixture is pozzolanic.

23. The alkali powder mixture of claim 19, wherein:
the ratio of PCWG to DCWF is from 1% to 99%.

24. The alkali powder mixture of claim 19, wherein:
the alkali content of the powder mixture is between 1% and 15%.
